(19) United States
(12) Patent Application Publication
(10) Pub. No.: US 2010/0155424 A1
(43) Pub. Date: Jun. 24, 2010

(54) Double component container

(76) Inventor: Wen-Chi Tsai, Dashe Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/588,893

(22) Filed: Nov. 2, 2009

(30) Foreign Application Priority Data
Dec. 18, 2008 (TW) 097149528

(51) Int. Cl. B67D 7/78

(52) U.S. Cl. 222/145.1

(57) ABSTRACT

A double component container is revealed. The double component container includes a main material tube and a subsidiary material tube. A discharge pipe part is formed on a front end of the main material tube and a plurality of positioning ribs is disposed projectingly around an inner wall of the discharge pipe part while those positioning ribs form a ring hole that is inserted by a discharge pipe part of the subsidiary material tube. The subsidiary material tube includes a plurality of sleeves sleeved with one another and connected with the discharge pipe part. Thereby in use, the main material tube and the subsidiary material tube respectively are filled with an adhesive and a hardener and then are pressed by a push out rod of an adhesive dispenser so as to push out the adhesive mixed with the hardener. Thus fast curing of the adhesive is achieved.

### BACKGROUND OF THE INVENTION

1. Fields of the Invention

The present invention relates to a double component container, especially to a container formed by a main material tube and a subsidiary material tube. The main material tube and the subsidiary material tube respectively are filled with an adhesive and a hardener therein. Thereby a push out rod in an adhesive dispenser available now presses against the main material tube and the subsidiary material tube simultaneously so as to force the adhesive mixed with the hardener out of the main material tube and the subsidiary material tube out. Thus the adhesive is cured quickly.

2. Descriptions of Related Art

Generally, waterproof adhesives such as epoxy resin available on the market now are applied to repair of gaps between bathroom tiles, reinforcement of fish tanks or sealed glass, or sealing of eaves gaps for waterproofing. Generally, after being applied by a dispenser, the adhesive is cured over a period of time. Under such condition, while being applied to a vertical plane, the uncured adhesive flows along the vertical plane downwards. This not only causes failure of the repair but also lead to stains on other places that need no repair. Especially dust and debris are easily attached to the uncured adhesive to make a stain.

Thus there is a dispenser in which a hardener is added simultaneously while pressing the adhesive for accelerating the curing so as to overcomes above shortcomings such as stains caused by uncured adhesive flowing through the vertical plane.

Refer to FIG. 9, an adhesive dispenser 5 that extrudes adhesives and hardeners (curing agents) simultaneously available now is revealed. A loading base 52 is formed on a dispenser body 51 and a grip 53 disposed on a rear side of the dispenser body 51. A lever 54 is arranged in front of the grip 53 and is connected with a main push out rod 55 that is mounted inside the loading base 52. The main push out rod 55 is pressing against a rear opening of an adhesive tube 6. Moreover, a subsidiary push out rod 56 is integrated with a rear side of the main push out rod 55 and is set concavely over the dispenser body 51. The subsidiary push out rod 56 is pressing against a material tube 7 with a hardener therein. A front opening of the material tube 7 with a hardener and a front opening of the adhesive tube 6 with an adhesive are both connected with an outlet part 8. Thereby when a user's hand holds the grip 53 and cocks the lever 54, the main push out rod 55 connected with the lever 54 presses the adhesive. Along with the forward movement of the main push out rod 55, the subsidiary push out rod 56 connected with the main push out rod 55 also presses the hardener. Both the adhesive and the hardener are pushed out through the outlet part 8 and are passing an injection tube 9 with a spiral stirrer 9 to mix the adhesive with the hardener evenly. Thus the adhesive is cured quickly.

However, in practice, such kind of adhesive dispenser 5 having the main push out rod 55 and the subsidiary push out rod 56 for pushing out the adhesive and the hardener simultaneously is with special specification and is used together with the special material tube 7 and the adhesive tube 6 integratedly. Thus once the user intends to use the special material tube 7 with the hardener and the adhesive tube 6 with the adhesive, he also needs to buy the adhesive dispenser 5 with special specification at the same time. An adhesive dispenser such as a silicon gun with a single push out rod available and popular on the market now is unable to be used. Thus it's a monopoly over a product and the consumer should accept the unreasonable price. Furthermore, the adhesive dispenser 5 with the specific specification can't put to other use. Thus it's used only a single time or a few times use and then is discarded. This is also a kind of waste.

Thus there is a need to invent an adhesive dispenser that overcomes shortcomings of the adhesive dispenser that pushes out the adhesive and the hardener simultaneously available now.

### SUMMARY OF THE INVENTION

Therefore it is a primary object of the present invention to provide a double component container that is used together with a dispenser having a single push out rod available now easily and conveniently so as to push out an adhesive and a hardener simultaneously and get a mixture of the adhesive with the hardener.

In order to achieve above object, a double component container of the present invention includes a main material tube and a subsidiary material tube. The main material tube is a hollow tube with a discharge pipe part on a front end thereof A plurality of positioning ribs is disposed projectingly around an inner wall of the discharge pipe part and those positioning ribs form a ring hole.

The subsidiary material tube formed by a plurality of sleeves sleeved with one another and a discharge pipe part is mounted in the main material tube. The discharge pipe part inserts into the ring hole formed by the positioning ribs of the main material tube. Moreover, a connection segment is formed on a rear end of the discharge pipe part so as to sleeve with the adjacent sleeve while a stopping edge is formed on a front side of the connection segment for pressing against the rear end of the positioning ribs. Furthermore, a step-like locking edge for locking with the front end of the positioning ribs is formed on the discharge pipe part. And a tube opening is formed on a front part of the discharge pipe part

Thereby, in practice, an adhesive and a hardener respectively are filled into the main material tube and the subsidiary material tube. Then the main material tube and the subsidiary material tube are pressed by a push out rod of an adhesive dispenser available now so as to mix and force the adhesive and the hardener in the main and the subsidiary material tubes out. Thus quick curing of the adhesive is achieved.

Moreover, the economic burden caused by buying the adhesive dispenser with specific specification is released. The waste resulted from less use or discarding of the adhesive dispenser with specific specification can also be prevented.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded view of an embodiment according to the present invention;

FIG. 2 is an enlarged view of a partial cross sectional view of an embodiment according to the present invention;

FIG. 3 is a cross sectional view of an embodiment according to the present invention;

FIG. 4 is an assembly view showing an embodiment of the present invention assembled with an adhesive dispenser;

FIG. 5 is another assembly view showing an embodiment of the present invention assembled with an adhesive dispenser;

FIG. 6 is a schematic drawing showing an embodiment of the present invention in a use state;

FIG. 7 is another schematic drawing showing an embodiment of the present invention in a use state;

FIG. 8 is a further schematic drawing showing an embodiment of the present invention in a use state;

FIG. 9 is a perspective view of a prior art.

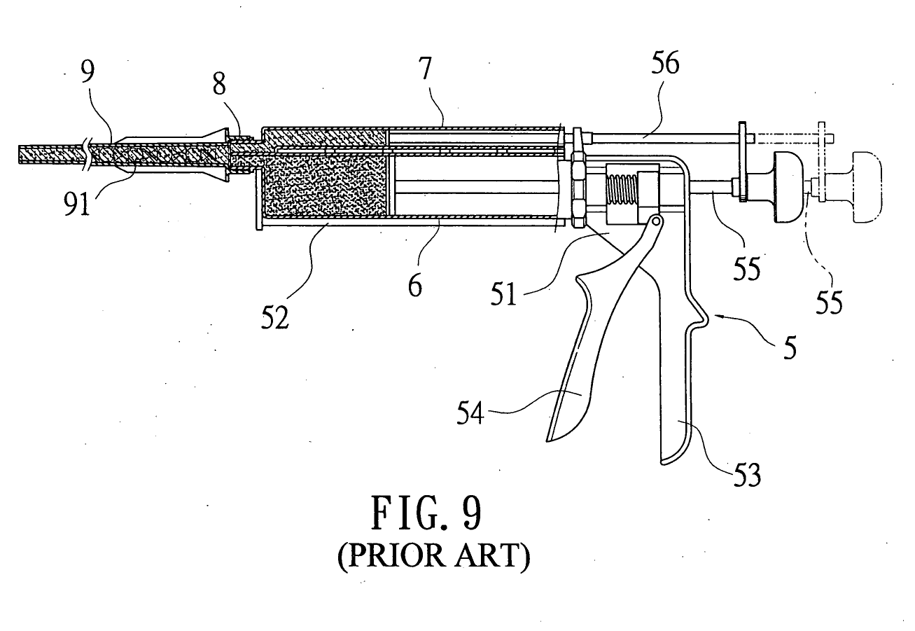

### DETAILED DESCRIPTION OF THE PREFERRED EMBODIMENT

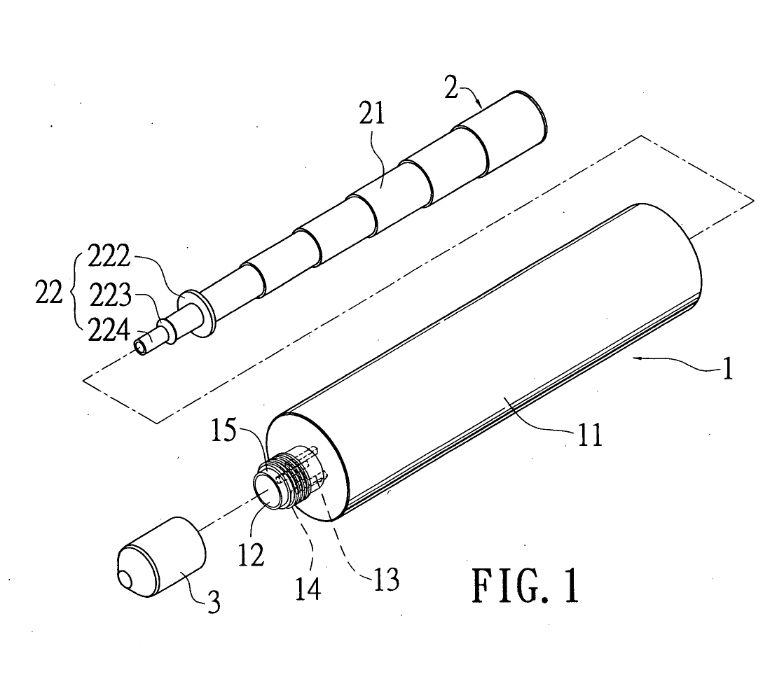

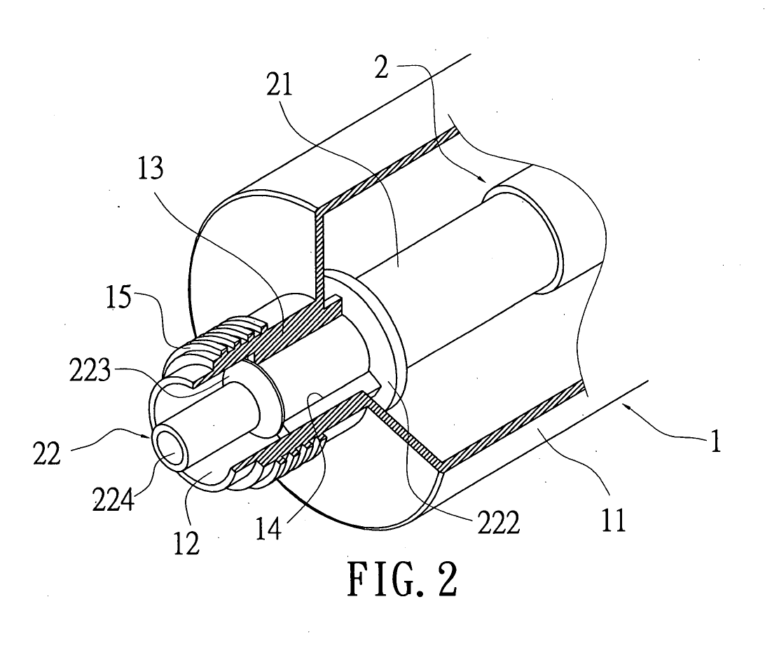

Refer to FIG. 1 and FIG. 2, a double component container mainly consists of a main material tube 1 and a subsidiary material tube 2.

The main material tube 1 includes a hollow tube 11, a discharge pipe part 12 on a front end thereof, a plurality of positioning ribs 13 disposed projectingly around an inner wall of the discharge pipe part 12, a ring hole 14 formed by the positioning ribs 13 arranged circularly, and an outer threaded part 15 formed on an outer wall of the discharge pipe part 12.

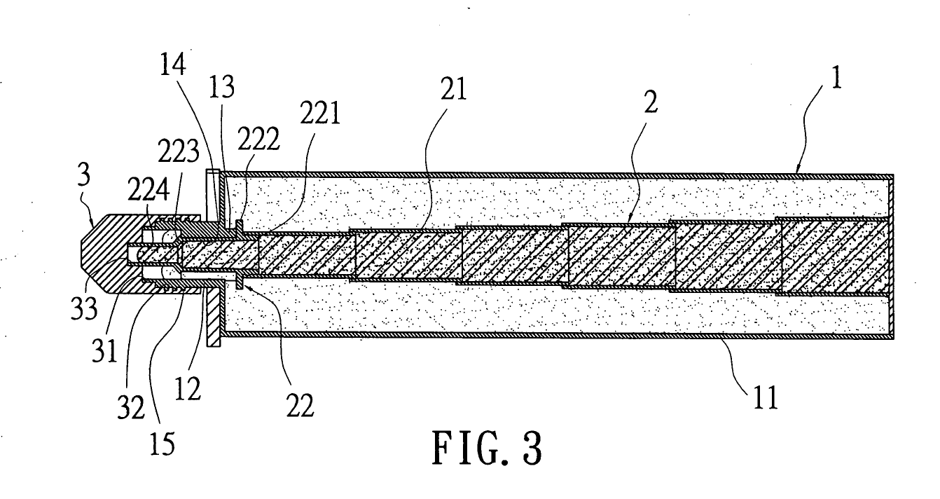

Refer to FIG. 3, the subsidiary material tube 2 formed by a plurality of sleeves 21 and a discharge pipe part 22 is mounted in the main material tube 1. The diameter of each sleeve 21 is gradually increased and the sleeves 21 are sleeved with one another. As to the discharge pipe part 22, it inserts into the ring hole 14 formed by the positioning ribs 13 of the main material tube 1. Moreover, a connection segment 221 is formed on a rear end of the discharge pipe part 22 so as to sleeve with the adjacent sleeve 21 while a stopping edge 222 is formed on a front side of the connection segment 221 for pressing against the rear end of the positioning ribs 13. Furthermore, a step-like locking edge 223 for locking with the front end of the positioning ribs 13 is formed on the discharge pipe part 22. A contracted tube opening 224 is formed on a front part of the discharge pipe part 22.

A plug sleeve 3 includes a receiving slot 31 corresponding to the discharge pipe part 12 on the front end of the main material tube 1. An inner threaded part 32 corresponding to the outer threaded part 15 of the discharge pipe part 12 of the main material tube 1 is disposed on a wall of the receiving slot 31 so as to thread with the outer threaded part 15 of the discharge pipe part 12. A cell 33 corresponding to the tube opening 224 of the discharge pipe part 22 of the subsidiary material tube 2 is disposed concavely on the bottom of the receiving slot 31.

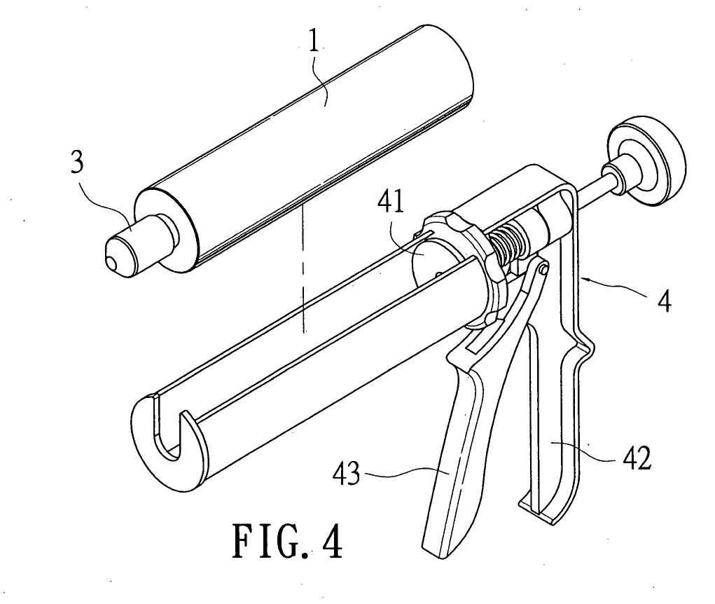

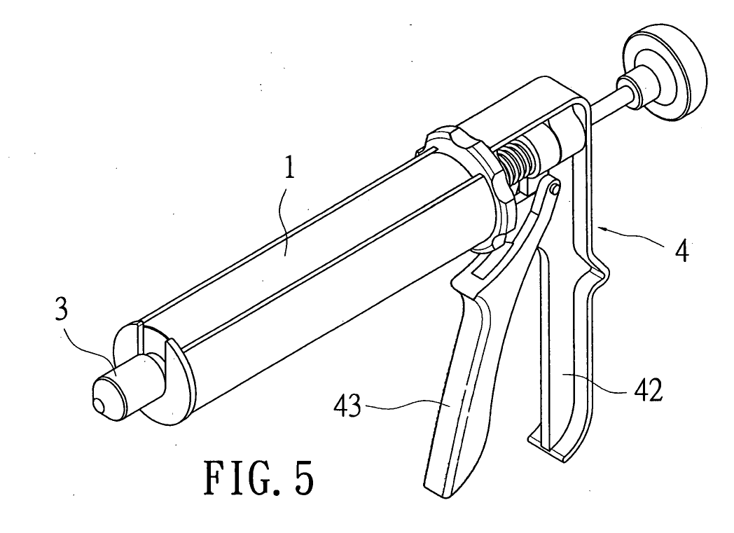

Thereby while in use, refer to FIG. 4 and FIG. 5, remove the plug sleeve 3 from the main and the subsidiary material tubes 1, 2. Then set the assembled main and the subsidiary material tubes 1, 2 respectively with the adhesive and the hardener therein onto an adhesive dispenser 4. The adhesive dispenser 4 can be those disclosed in Taiwanese Pat. App. Pub. No. 540431-“improved adhesive dispenser”, Taiwanese Pat. App. Pub. No. 469879, Taiwanese Pat. App. Pub. No. 469881, Taiwanese Pat. App. Pub. No. 121307, and so on. Those are all an adhesive dispenser with a single push out rod 41 available on the market and the push out rod 41 of the adhesive dispenser 4 presses against rear ends of the main and the subsidiary material tubes 1, 2.

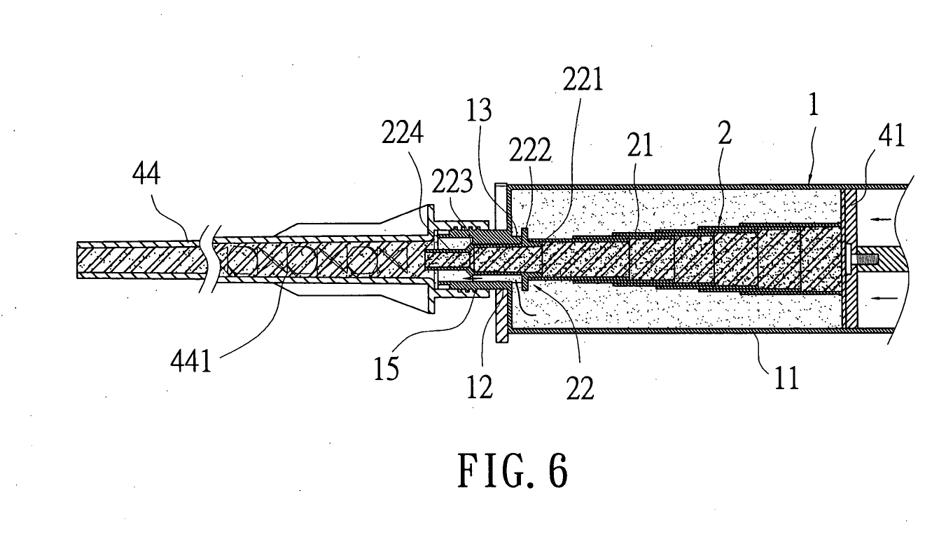

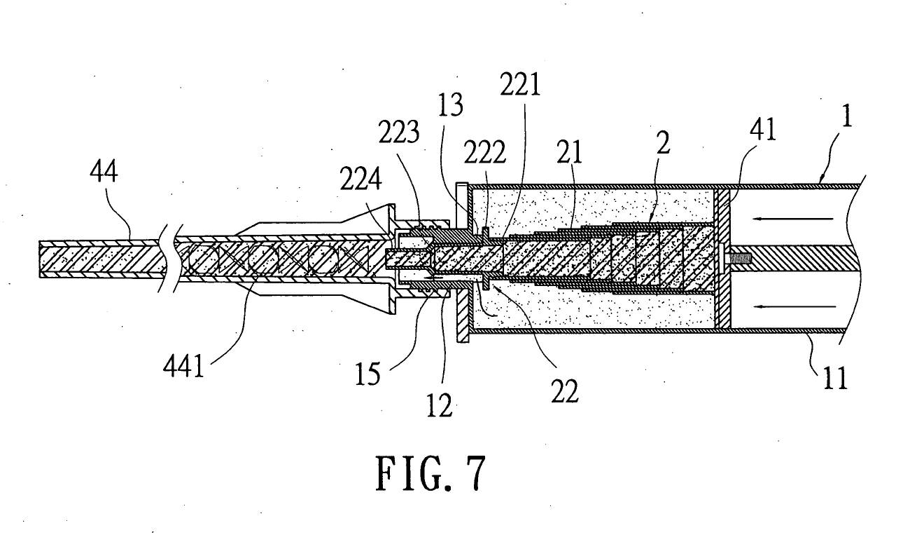

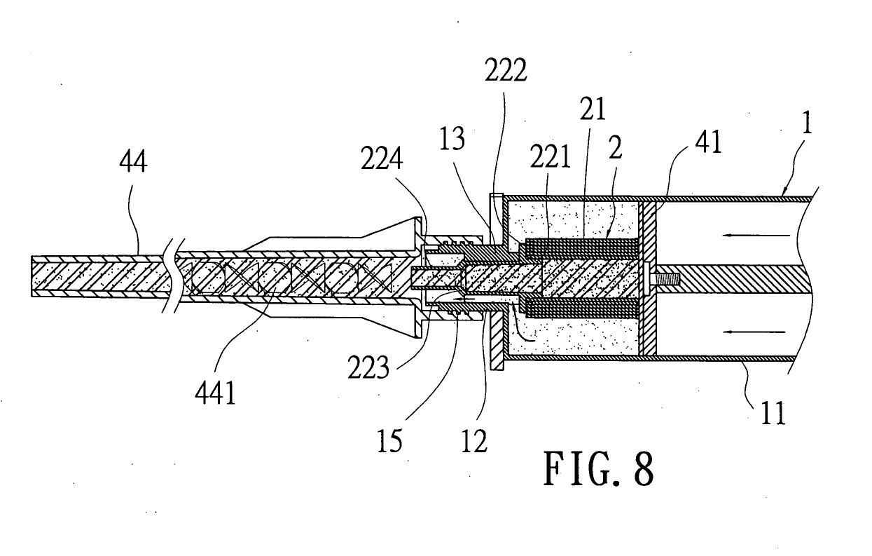

Refer to FIG. 6 to FIG. 8, a filler tube 44 with a spiral stirrer 441 is installed at the discharge pipe parts 12, 22 of the main and the subsidiary material tubes 1, 2. Then the grip 42 of the adhesive dispenser 4 is held by a user's hand and a lever 43 of the adhesive dispenser 4 is pulled so as to make the push out rod 41 connected with the lever 43 move forward to press against the main and the subsidiary material tubes 1, 2. Thus the adhesive and the hardener filled in the main and the subsidiary material tubes 1, 2 are pushed simultaneously by the push out rod 41 and are discharged from the discharge pipe parts 12, 22 of the main and the subsidiary material tubes 1, 2. In the filler tube 44, the adhesive and the hardener are mixed well by the spiral stirrer 441. Next the mixed adhesive with the hardener is pushed out through the front end of the filler tube 44 to coat the positions that need repair such as gaps between bathroom tiles, fish tanks or eaves. Or before steel bars and bolts being embedded into concrete, an adhesive is applied to predrilled holes. After pushing out from the adhesive dispenser 4, the adhesive is cured quickly due to the hardener added therein so as to make the embedded steel bars connect with the concrete firmly. Moreover, while the adhesive being applied to object repair such as gaps between bathroom tiles, fish tanks or eaves, dirt on the adhesive due to attachment of dust and debris on the adhesive caused by long curing time of the adhesive can be avoided. Furthermore, a few strips of adhesive smudges formed on a vertical surface or wall resulted from long curing time can be prevented.

Thereby the double component container of the present invention is applied to a common adhesive dispenser available now on the market. There is no need to buy the adhesive dispenser with special specification. Thus the consumers save their money, reduce their economic burden. Furthermore, without the use of the adhesive dispenser with special specification, the waste caused by less use or discarding is avoided.

In summary, the present invention has a plurality of advantages, such as:
1. The double component container of the present invention can be used in combination with adhesive dispensers such as silicon guns available on the market now. Thus there is no need for consumers to buy another adhesive dispenser with special specification. They can use the adhesive dispenser they already have together with the double component container so as to push out the adhesive mixed with the hardener easily and conveniently. The mixture is coated on places intended to be repaired such as gaps between bathroom tiles, fish tanks and eaves, or is filled into predrilled holes in concrete for embedding steel bars and bolts. Thus quick curing in a short time is achieved.
2. The double component container of the present invention can be used together with adhesive dispensers available on the market now. Thus there is no need for users to buy another adhesive dispenser with special specification and high cost. Therefore, the expenses and burden are reduced.
3. The double component container of the present invention can be used together with adhesive dispensers available on the market now. Thus there is no need to use adhesive dispensers with special specification and the waste caused by less use or discarding can be prevented.
4. The double component container of the present invention further includes a plug sleeve that is covered on the front end of the main and the subsidiary material tubes correspondingly. The plug sleeve is disposed with a receiving slot corresponding to the discharge pipe part of the main material tube. And a cell corresponding to the tube opening of the discharge pipe part of the subsidiary material tube is arranged concavely on the bottom of the receiving slot. Thereby the plug sleeve can plug the tube openings of the main and the subsidiary material tubes simultaneously. There is no need to set a respective cap for each material tube. Thus there is no need to put the caps on or remove the caps from the main and the subsidiary material tubes respectively. This provides convenience in use.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A double component container comprising:
a main material tube that is a hollow tube with a discharge pipe part on a front end thereof, and
a subsidiary material tube mounted in the main material tube and having a plurality of sleeves sleeved with one another while the diameter of each sleeve being gradually increased and a tube opening of the sleeve corresponding to the discharge pipe part of the main material tube.

2. The device as claimed in claim 1, wherein a plurality of positioning ribs is disposed projectingly around an inner wall of the discharge pipe part on the front end of the main material tube and the positioning ribs form a ring hole while the subsidiary material tube having a discharge pipe part that inserts into the ring hole formed by the positioning ribs of the main material tube, and further having a connection segment formed on a rear end of the discharge pipe part so as to sleeve with the adjacent sleeve; a stopping edge is formed on a front side of the connection segment so as to press against the rear end of the positioning ribs and a step-like locking edge for locking with the front end of the positioning ribs is formed on the discharge pipe part of the subsidiary material tube; a tube opening is formed on a front part of the discharge pipe part of the subsidiary material tube.

3. The device as claimed in claim 2, wherein the tube opening on the discharge pipe part of the subsidiary material tube is contracted relatively to the discharge pipe part.

4. The device as claimed in claim 2, wherein the double component container further includes a plug sleeve that covers the front end of the main material tube and the subsidiary material tube and the plug sleeve having a receiving slot corresponding to the discharge pipe part on the front end of the main material tube and a cell corresponding to the tube opening of the discharge pipe part of the subsidiary material tube formed concavely on the bottom of the receiving slot.
